(19) United States
(12) Patent Application Publication
(10) Pub. No.: US 2024/0051402 A1
(43) Pub. Date: Feb. 15, 2024

(54) VEHICLE

(71) Applicant: SUBARU CORPORATION, Tokyo (JP)

(72) Inventor: Chihiro OGURO, Tokyo (JP)

(21) Appl. No.: 18/224,449

(22) Filed: Jul. 20, 2023

(30) Foreign Application Priority Data
Aug. 12, 2022 (JP) 2022-128974

(51) Int. Cl. B60L 15/20

(52) U.S. Cl. CPC B60L 15/20; B60L 2240/463; B60L 2240/465

(57) ABSTRACT

A vehicle includes driving wheels, motors respectively and independently provided to the driving wheels, and a controller includes a processor and a storage medium. The processor detects at least one first driving wheel having a higher load and at least one second driving wheel having a lower load in forward movement, detects at least one third driving wheel having a higher load and at least one fourth driving wheel having a lower load in backward movement, and alternately switches the forward movement and the backward movement. The forward movement includes applying, to the second driving wheel, a torque for obtaining a slip ratio of 0%, and applying, to the first driving wheel, a torque that causes a slip. The backward movement includes applying, to the fourth driving wheel, a torque for obtaining the slip ratio of 0%, and applying, to the third driving wheel, a torque that causes a slip.

### CROSS-REFERENCE TO RELATED APPLICATIONS

The present application claims priority from Japanese Patent Application No. 2022-128974 filed on Aug. 12, 2022, the entire contents of which are hereby incorporated by reference.

### BACKGROUND

The disclosure relates to a vehicle.

In this technical field, there is proposed a function to assist traveling of a vehicle on a low-friction road. For example, Japanese Unexamined Patent Application Publication No. 2005-161961 discloses an automobile including a controller that adjusts the ratio of torques to be distributed to front wheels and rear wheels in the event of a slip. When a slip is detected, the controller adjusts the ratio of torques to set a smaller torque to be distributed to a wheel where the slip has been detected.

### SUMMARY

An aspect of the disclosure provides a vehicle. The vehicle includes driving wheels, motors, and a controller. The driving wheels include right and left front driving wheels and right and left rear driving wheels. The motors are respectively and independently provided to the driving wheels. The controller is configured to control the motors. The controller includes one or more processors and one or more storage media. The one or more storage media are configured to store a command to be executed by the one or more processors. The one or more processors are configured to, based on the command when a predetermined operation is received from a driver who drives the vehicle: detect, among the driving wheels, at least one driving wheel having a higher load and at least one driving wheel having a lower load, in forward movement; detect, among the driving wheels, at least one driving wheel having a higher load and at least one driving wheel having a lower load in backward movement; and alternately switch the forward movement and the backward movement. The forward movement includes applying, to the at least one driving wheel having the lower load in the forward movement, a torque at which a slip ratio of 0% is obtained, and applying, to the at least one driving wheel having the higher load in the forward movement, a torque that causes a slip. The backward movement includes applying, to the at least one driving wheel having the lower load in the backward movement, a torque at which the slip ratio of 0% is obtained, and applying, to the at least one driving wheel having the higher load in the backward movement, a torque that causes a slip.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a vehicle according to an embodiment;

FIG. 2 is a functional block diagram of an ECU;

FIG. 3 is a graph illustrating a relationship between a slip ratio and a gripping force;

FIG. 4 is a schematic side view illustrating an example of a stuck vehicle;

FIG. 5 is graphs illustrating transition of a torque and a vehicle speed in second control;

FIG. 6 is a flowchart illustrating operation of a controller;

FIG. 7 is a flowchart that follows FIG. 6; and

FIG. 8 is a flowchart that follows FIG. 7.

### DETAILED DESCRIPTION

When a vehicle is stuck on a low-friction road such as a frozen or snowy road, a driver who drives the vehicle may have a difficulty in moving the vehicle by manual driving due to a slip of a wheel.

It is desirable to provide a vehicle that can automatically move when the vehicle is stuck on a low-friction road.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

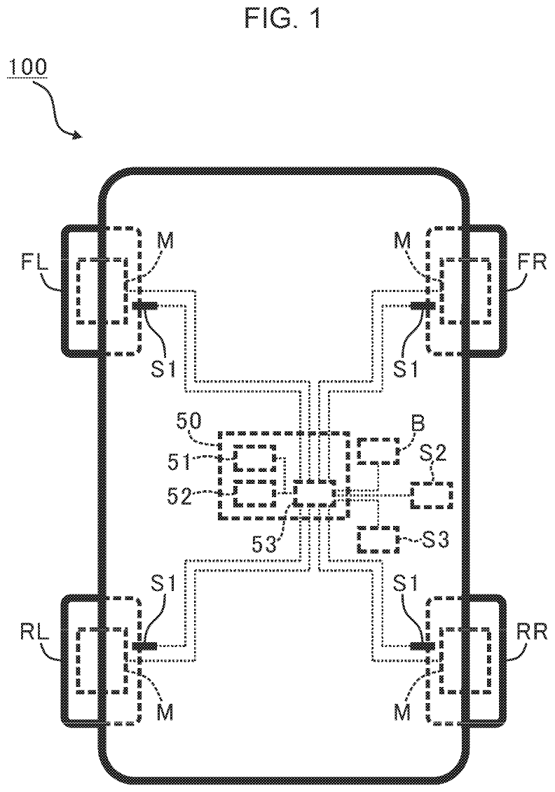

FIG. 1 is a schematic diagram illustrating a vehicle 100 according to the embodiment. The vehicle 100 includes driving wheels FR, FL, RR, and RL, motors M, wheel speed sensors S1, a global positioning system (GPS) sensor S2, an acceleration sensor S3, a button (inputter) B, and an ECU 50. In one embodiment, the ECU 50 may serve as a “controller”. The vehicle 100 may further include various other components. The vehicle 100 may omit one or more of the components described above.

In this embodiment, the vehicle 100 includes four driving wheels that are the right front wheel FR, the left front wheel FL, the right rear wheel RR, and the left rear wheel RL. The number of driving wheels is not limited to four. In another embodiment, the vehicle 100 may further include one or more driven wheels that are not coupled to the motors M.

The motors M are individually provided as driving sources to the driving wheels FR, FL, RR, and RL. Examples of the motor M include an in-wheel motor. For example, the motor M may be coupled to the wheel directly or via a gear. The motor M is communicatively coupled to the ECU 50. The ECU 50 controls operation of the motor M.

The wheel speed sensors S1 are provided to the respective driving wheels FR, FL, RR, and RL. The wheel speed sensor S1 detects a rotation speed of the wheel. The wheel speed sensor S1 is communicatively coupled to the ECU 50, and transmits detected data to the ECU 50.

The GPS sensor S2 receives positional information of the vehicle 100 from satellites. The GPS sensor S2 is communicatively coupled to the ECU 50, and transmits the received positional information to the ECU 50.

The acceleration sensor S3 detects an acceleration of the vehicle 100 in at least a longitudinal direction (fore-and-aft direction). The acceleration sensor S3 may further detect accelerations of the vehicle 100 in a lateral direction (right-and-left direction) and a vertical direction (up-and-down direction). The acceleration sensor S3 is communicatively coupled to the ECU 50, and transmits detected data to the ECU 50.

The button B is an inputter to be used for executing recovery operation described later. The button B may be provided near a driver's seat within a range that can be reached by the driver's hand, such as a steering wheel. Examples of the button B include a mechanical button and a button displayed on a touch panel. The inputter to be used for executing the recovery operation is not limited to the button B, and may be any other component such as a paddle near the steering wheel. The button B is communicatively coupled to the ECU 50. The ECU 50 executes the recovery operation when the button B is depressed.

For example, the ECU 50 includes one or more processors 51 such as a CPU, one or more storage media 52 such as a ROM and a RAM, and one or more connectors 53. The ECU 50 may further include any other component. The components of the ECU 50 are communicatively coupled to each other by a bus. The storage medium 52 stores one or more programs to be executed by the processor 51. The programs include commands for the processor 51. The operation of the ECU 50 according to the embodiment of the disclosure is implemented by the processor 51 executing the commands stored in the storage medium 52. The ECU 50 is communicatively coupled to the components of the vehicle 100 via the connector 53.

As described above, the ECU 50 executes the recovery operation for automatically moving the vehicle 100 when the button B is depressed. For example, the driver may depress the button B when the vehicle 100 is stuck and the driver cannot move the vehicle 100 by manual driving. The recovery operation is particularly effective on a low-friction road such as a frozen or snowy road. The recovery operation may be executed also when the vehicle 100 is stuck on a normal road. The recovery operation includes first control and second control (rocking control) described later.

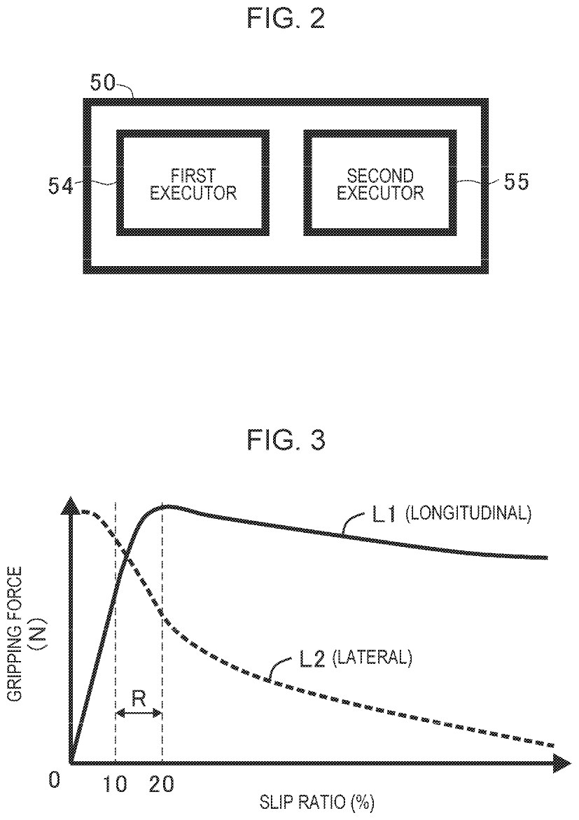

FIG. 2 is a functional block diagram of the ECU 50. The processor 51 serves as a first executor 54 that executes the first control and a second executor 55 that executes the second control based on a command stored in the storage medium 52 when the button B is depressed.

FIG. 3 is a graph illustrating an example of a relationship between a slip ratio and a gripping force. In FIG. 3, the horizontal axis represents the slip ratio. The slip ratio is calculated from “slip ratio (%)=(wheel speed−body speed)/body speed×100”. In FIG. 3, the vertical axis represents the gripping force. The solid line L1 represents a longitudinal gripping force. The broken line L2 represents a lateral gripping force.

As indicated by the solid line L1, the longitudinal gripping force is highest when the slip ratio is about 20%, that is, when the driving wheel is slipping to some extent. That is, the longitudinal gripping force is not highest when the slip ratio is 0%, that is, the driving wheel is not slipping. When the vehicle 100 is stuck, the driving wheel can obtain the highest longitudinal gripping force by applying, to the driving wheel, a torque that causes a slip to some extent.

As indicated by the broken line L2, the lateral gripping force is highest when the slip ratio is 0%, that is, the driving wheel is not slipping.

In view of the findings described above, the processor 51 executes the first control. The first control includes moving the vehicle 100 forward and backward while applying, to the driving wheels FR, FL, RR, and RL, torques that cause slips to some extent.

For example, the “torque that causes a slip to some extent” may mean a torque at which a slip ratio within a predetermined target range R is obtained, including the slip ratio at which the highest longitudinal gripping force is obtained (in the example of FIG. 3, the slip ratio of about 20%). For example, the target range R may be 10% or higher and 20% or lower. The target range R is not limited to this range, and may be changed depending on various factors such as a vehicle type. In the embodiment of the disclosure, the “torque at which the slip ratio within the target range R is obtained” is also referred to as “high-gripping torque”. In the first control of this embodiment, the high-gripping torques are applied to all the driving wheels FR, FL, RR, and RL. The torque that causes a slip changes depending on a load applied to each wheel. Therefore, the high-gripping torque also changes depending on the load applied to each wheel. When a certain driving wheel greatly slips during the first control, the processor 51 need not apply the torque to this driving wheel. The “torque that causes a slip to some extent” may alternatively mean a torque at which a slip ratio higher than 0 is obtained.

In the first control, the wheel speed for use in the calculation of the slip ratio can be acquired from the wheel speed sensor S1 of each of the driving wheels FR, FL, RR, and RL. The body speed (vehicle speed) may be calculated based on positional information acquired from the GPS sensor S2. The body speed may alternatively or additionally be calculated based on data detected by the acceleration sensor S3.

During the first control, the processor 51 detects at least one driving wheel having a higher load and at least one driving wheel having a lower load in each of the forward movement and the backward movement.

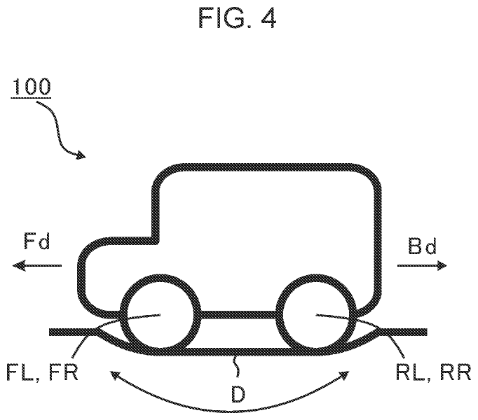

FIG. 4 is a schematic side view illustrating an example of the stuck vehicle 100. In the example of FIG. 4, the vehicle 100 is stuck in a depression D on a low-friction road. When the vehicle 100 moves in a forward direction Fd during the first control, the front part of the vehicle 100 is raised. In this case, the rear driving wheels RR and RL have higher loads, and the front driving wheels FR and FL have lower loads. As described above, the high-gripping torques are applied to all the driving wheels FR, FL, RR, and RL in the first control, and the high-gripping torques change depending on the loads applied to the individual wheels. Therefore, higher torques are applied to the rear driving wheels RR and RL having higher loads, and lower torques are applied to the front driving wheels FR and FL having lower loads. Thus, the processor 51 can detect the driving wheels having higher loads and the driving wheels having lower loads in the forward movement by reading the torques output by the motors M during the forward movement.

When the vehicle 100 moves in a backward direction Bd during the first control, the rear part of the vehicle 100 is raised. In this case, the front driving wheels FR and FL have higher loads, and the rear driving wheels RR and RL have lower loads. Therefore, higher torques are applied to the front driving wheels FR and FL having higher loads, and lower torques are applied to the rear driving wheels RR and RL having lower loads. Thus, the processor 51 can detect the driving wheels having higher loads and the driving wheels having lower loads in the backward movement by reading the torques output by the motors M during the backward movement.

The method for detecting the driving wheels having higher loads and the driving wheels having lower loads is not limited to this method. For example, any other sensor such as the acceleration sensor S3 or a gradient sensor (not illustrated) may be used. For example, when the rise of the front part of the vehicle 100 is detected by the acceleration sensor S3 or the gradient sensor in the example of FIG. 4, the processor 51 may determine that the rear driving wheels RR and RL have higher loads and the front driving wheels FR and FL have lower loads. When the rise of the rear part of the vehicle 100 is detected by the acceleration sensor S3 or the gradient sensor in the example of FIG. 4, the processor 51 may determine that the front driving wheels FR and FL have higher loads and the rear driving wheels RR and RL have lower loads.

When the vehicle 100 does not move though the first control is executed, the processor 51 executes the second control. The second control includes alternately switching the forward movement and the backward movement. In the second control, zero-slip torques, that is, torques at which slip ratios of 0% are obtained are applied to the driving wheels having lower loads. The zero-slip torque is lower than the high-gripping torque at which the slip ratio within the target range R is obtained.

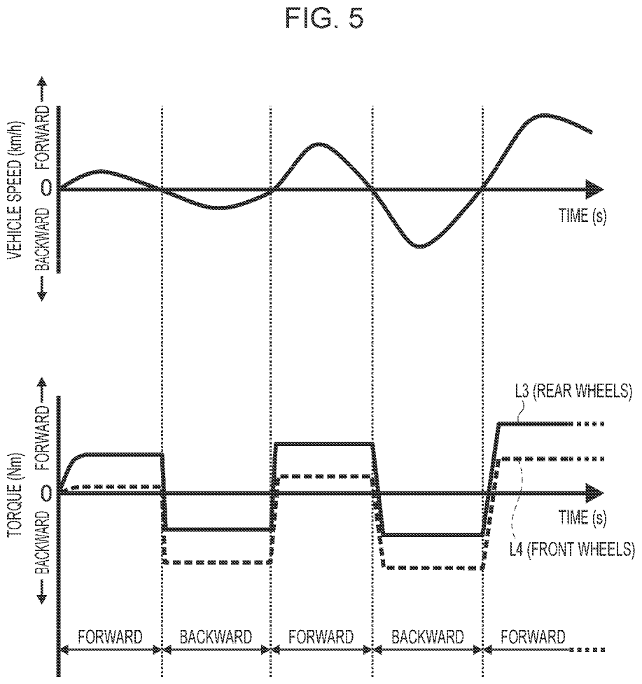

FIG. 5 is graphs illustrating transition of the torque and the vehicle speed in the second control. FIG. 5 illustrates an example of the torque and the vehicle speed applied to the vehicle 100 in the example of FIG. 4. In the upper and lower graphs, the horizontal axis represents time.

In the upper graph, the vertical axis represents the vehicle speed. Both the vehicle speeds in the forward movement and the backward movement are represented as positive values (absolute values). In the lower graph, the vertical axis represents the torque. Both the torques in the forward movement and the backward movement are represented as positive values (absolute values). In the lower graph, the solid line L3 represents torques applied to the rear driving wheels RR and RL, and the broken line L4 represents torques applied to the front driving wheels FR and FL.

When the vehicle 100 moves forward in the example of FIG. 4, the rear driving wheels RR and RL have higher loads and the front driving wheels FR and FL have lower loads as described above. As illustrated in FIG. 5, the high-gripping torques are applied to the rear driving wheels RR and RL having higher loads and the zero-slip torques are applied to the front driving wheels FR and FL having lower loads in the forward movement.

In the backward movement, the front driving wheels FR and FL have higher loads and the rear driving wheels RR and RL have lower loads. In the backward movement, the high-gripping torques are applied to the front driving wheels FR and FL having higher loads and the zero-slip torques are applied to the rear driving wheels RR and RL having lower loads.

When all the driving wheels FR, FL, RR, and RL have the same loads, the zero-slip torques may be applied to leading driving wheels and the high-gripping torques may be applied to trailing driving wheels during the second control. When a certain driving wheel greatly slips during the second control, the processor 51 need not apply the torque to this driving wheel.

As illustrated in FIG. 5, the forward movement is switched to the backward movement when the forward movement is stopped, that is, when the vehicle speed in the forward movement decreases to zero. The backward movement is switched to the forward movement when the backward movement is stopped, that is, when the vehicle speed in the backward movement decreases to zero. By alternately switching the forward movement and the backward movement in the second control, the vehicle 100 rocks like a pendulum and the vehicle speed increases as illustrated in FIG. 5. Thus, the vehicle 100 can move out of the depression D. The forward movement may be switched to the backward movement when the forward movement is assumed to be stopped, that is, when the vehicle speed in the forward movement decreases below a predetermined value. The backward movement may be switched to the forward movement when the backward movement is assumed to be stopped, that is, when the vehicle speed in the backward movement decreases below a predetermined value.

In the second control, the wheel speed for use in the calculation of the slip ratio can be acquired from the wheel speed sensor S1 of each of the driving wheels FR, FL, RR, and RL. In the second control, the body speed (vehicle speed) can be calculated based on data detected by the wheel speed sensor S1 of the driving wheel to which the zero-slip torque is applied.

For example, in a case where the motor M is coupled to the wheel via gears, a backlash may cause noise and shock when the torque is switched from a forward rotation torque to a backward rotation torque or from a backward rotation torque to a forward rotation torque. To avoid the noise and shock, the vehicle 100 may gradually change the torque when the torque crosses zero. This control may be referred to as “zero-cross control”. In the second control, the processor 51 need not execute the zero-cross control because the forward movement and the backward movement are alternately switched quickly.

In the first control and the second control, the vehicle speed is zero when the torque is applied to each driving wheel for the first time. Therefore, there is a possibility that the zero-slip torque and the high-gripping torque cannot be obtained accurately. In this case, the ECU 50 may store an initial torque in the storage medium 52. When the torque is applied to each driving wheel for the first time, the processor 51 may gradually increase the torque until the initial torque is obtained.

The operation of the ECU 50 is described.

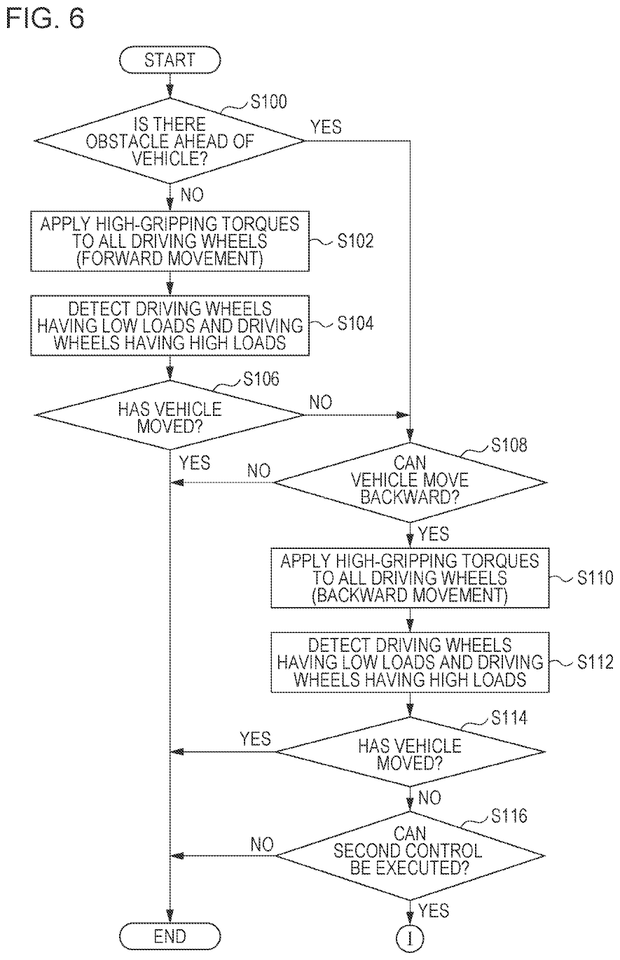

FIG. 6 is a flowchart illustrating the operation of the ECU 50. FIG. 6 illustrates the first control. In the example of FIG. 6, the traveling direction of the vehicle 100 is a forward direction. The traveling direction of the vehicle 100 can be detected from, for example, the position on a select lever of transmission (not illustrated). For example, the operation illustrated in FIG. 6 is started when the button B is depressed by the driver.

The processor 51 of the ECU 50 determines whether an obstacle is present ahead of the vehicle 100 (Step S100). For example, the processor 51 may execute Step S100 based on an image obtained by a camera (not illustrated) of the vehicle 100.

When no obstacle is present ahead of the vehicle 100 in Step S100 (NO), the processor 51 applies the high-gripping torques to all the driving wheels FR, FL, RR, and RL to move the vehicle 100 forward (Step S102).

During the forward movement, the processor 51 detects driving wheels having higher loads and driving wheels having lower loads (Step S104).

The processor 51 determines whether the vehicle 100 has moved (Step S106). For example, the processor 51 may determine whether the vehicle 100 has moved by a predetermined distance (for example, a distance corresponding to one wheelbase) based on positional information obtained from the GPS sensor S2 or data detected by the acceleration sensor S3.

When the vehicle 100 has moved in Step S106 (YES), the processor 51 terminates the operation. For example, the processor 51 may notify the driver by display or voice that the vehicle 100 has moved safely.

When an obstacle is present ahead of the vehicle 100 in Step S100 (YES) or when the vehicle 100 has not moved in Step S106 (NO), the processor 51 determines whether the vehicle 100 can move backward (Step S108). For example, the processor 51 may inquire of the driver whether to move backward. The processor 51 may alternatively or additionally determine whether an obstacle is present behind the vehicle 100 based on an image obtained by a camera.

When the vehicle 100 cannot move backward in Step S108 (NO), the processor 51 terminates the operation. For example, the processor 51 may notify the driver by display or voice that the vehicle 100 cannot move.

When the vehicle 100 can move backward in Step S108 (YES), the processor 51 applies the high-gripping torques to all the driving wheels FR, FL, RR, and RL to move the vehicle 100 backward (Step S110).

During the backward movement, the processor 51 detects driving wheels having higher loads and driving wheels having lower loads (Step S112).

The processor 51 determines whether the vehicle 100 has moved (Step S114). Step S114 may be the same as Step S106.

When the vehicle 100 has moved in Step S114 (YES), the processor 51 terminates the operation. In this case, the processor 51 may notify the driver by display or voice that the vehicle 100 has moved safely.

When the vehicle 100 has not moved in Step S114 (NO), the processor 51 determines whether the second control can be executed (Step S116). For example, the processor 51 may inquire of the driver whether to execute the second control including rocking the vehicle 100. The processor 51 may determine whether an obstacle is present ahead of or behind the vehicle. When an obstacle is present ahead of or behind the vehicle, the processor 51 may determine that the second control cannot be executed.

When the second control can be executed in Step S116 (YES), the processor 51 proceeds to Step S200.

When the second control cannot be executed in Step S116 (NO), the processor 51 terminates the operation. For example, the processor 51 may notify the driver by display or voice that the vehicle 100 cannot move.

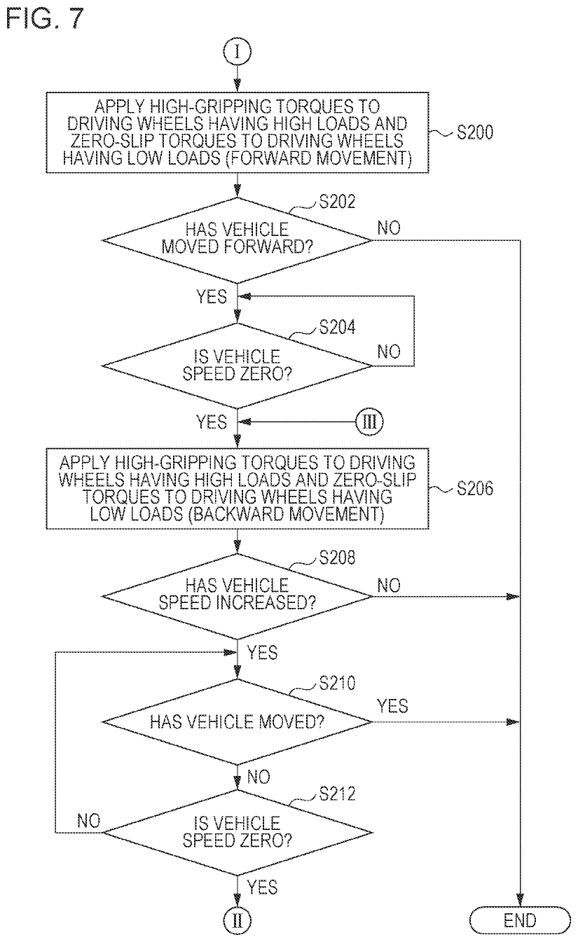

FIG. 7 is a flowchart that follows FIG. 6. FIG. 7 illustrates a part of the second control.

Based on the detection result of Step S104, the processor 51 applies the high-gripping torques to the rear driving wheels RR and RL having higher loads and the zero-slip torques to the front driving wheels FR and FL having lower loads to move the vehicle 100 forward (Step S200).

The processor 51 determines whether the vehicle 100 has moved forward (Step S202). For example, the processor 51 may determine whether the vehicle speed has increased based on data detected by the wheel speed sensors S1 of the front driving wheels FR and FL to which the zero-slip torques are applied.

When the vehicle 100 has moved forward in Step S202 (YES), the processor 51 determines whether the vehicle speed has decreased to zero (Step S204). The processor 51 may alternatively determine whether the vehicle speed has decreased below a predetermined value. When the vehicle speed has not decreased to zero in Step S204 (NO), the processor 51 repeats Step S204 until the vehicle speed decreases to zero.

When the vehicle speed has decreased to zero in Step S204 (YES), the processor 51 applies the high-gripping torques to the front driving wheels FR and FL having higher loads and the zero-slip torques to the rear driving wheels RR and RL having lower loads based on the detection result of Step S112 to move the vehicle 100 backward (Step S206). That is, the processor 51 switches the vehicle 100 from the forward movement to the backward movement.

The processor 51 determines whether the vehicle speed has increased compared with the vehicle speed in the forward movement (Step S208).

When the vehicle speed has increased in Step S208 (YES), the processor 51 determines whether the vehicle 100 has moved (Step S210). Step S210 may be the same as Steps S106 and S114.

When the vehicle 100 has moved in Step S210 (YES), the processor 51 terminates the operation. In this case, the processor 51 may notify the driver by display or voice that the vehicle 100 has moved safely.

When the vehicle 100 has not moved in Step S210 (NO), the processor 51 determines whether the vehicle speed has decreased to zero (Step S212). The processor 51 may alternatively determine whether the vehicle speed has decreased below a predetermined value. When the vehicle speed has not decreased to zero in Step S212 (NO), the processor 51 repeats Steps S210 and S212 until the vehicle speed decreases to zero.

When the vehicle speed has decreased to zero in Step S212 (YES), the processor 51 proceeds to Step S300.

When the vehicle 100 has not moved forward in Step S202 (NO) or when the vehicle speed has not increased in Step S208 (NO), that is, when the vehicle speed has not increased though the vehicle 100 is switched from the forward movement to the backward movement, the processor 51 terminates the operation. For example, the processor 51 may notify the driver by display or voice that the vehicle 100 cannot move.

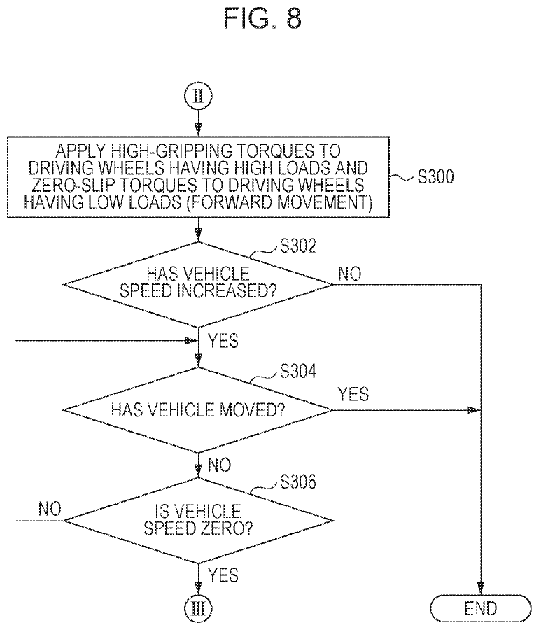

FIG. 8 is a flowchart that follows FIG. 7. FIG. 8 illustrates the remaining part of the second control.

Based on the detection result of Step S104, the processor 51 applies the high-gripping torques to the rear driving wheels RR and RL having higher loads and the zero-slip torques to the front driving wheels FR and FL having lower loads to move the vehicle 100 forward (Step S300).

The processor 51 determines whether the vehicle speed has increased compared with the vehicle speed in the backward movement (Step S302).

When the vehicle speed has increased in Step S302 (YES), the processor 51 determines whether the vehicle 100 has moved (Step S304). Step S304 may be the same as Steps S106, S114, and S210.

When the vehicle 100 has moved in Step S304 (YES), the processor 51 terminates the operation. In this case, the processor 51 may notify the driver by display or voice that the vehicle 100 has moved safely.

When the vehicle 100 has not moved in Step S304 (NO), the processor 51 determines whether the vehicle speed has decreased to zero (Step S306). The processor 51 may alternatively determine whether the vehicle speed has decreased below a predetermined value. When the vehicle speed has not decreased to zero in Step S306 (NO), the processor 51 repeats Steps S304 and S306 until the vehicle speed decreases to zero.

When the vehicle speed has decreased to zero in Step S306 (YES), the processor 51 returns to Step S206 of FIG. 7.

When the vehicle speed has not increased in Step S302 of FIG. 8 (NO), that is, when the vehicle speed has not increased though the forward movement and the backward movement are switched, the processor 51 terminates the operation. For example, the processor 51 may notify the driver by display or voice that the vehicle 100 cannot move.

The vehicle 100 described above includes the right and left front driving wheels FR and FL, the right and left rear driving wheels RR and RL, the motors M independently provided to the driving wheels FR, FL, RR, and RL in a one-on-one relationship, and the ECU 50 that controls the motors M. The ECU 50 includes the one or more processors 51 and the one or more storage media 52 that store the command to be executed by the processor 51. The processor 51 is configured to, based on the command when a predetermined operation is received from the driver, detect the rear driving wheels RR and RL having higher loads and the front driving wheels FR and FL having lower loads in the forward movement, detect the front driving wheels FR and FL having higher loads and the rear driving wheels RR and RL having lower loads in the backward movement, and alternately switch the forward movement and the backward movement. The forward movement includes applying the zero-slip torques to the front driving wheels FR and FL having lower loads in the forward movement and the high-gripping torques that cause slips to the rear driving wheels RR and RL having higher loads in the forward movement. The backward movement includes applying the zero-slip torques to the rear driving wheels RR and RL having lower loads in the backward movement and the high-gripping torques that cause slips to the front driving wheels FR and FL having higher loads in the backward movement. According to this configuration, the vehicle 100 rocks like a pendulum and the vehicle speed increases by alternately switching the forward movement and the backward movement. Thus, the vehicle 100 can automatically move when the vehicle 100 is stuck on a low-friction road.

In the vehicle 100, the forward movement is switched to the backward movement when the forward movement is stopped, and the backward movement is switched to the forward movement when the backward movement is stopped. According to this configuration, the vehicle speed may further increase.

Although the embodiment has been described above with reference to the accompanying drawings, the embodiment of the disclosure is not limited to this embodiment. It is understood that various modifications and revisions are conceivable by persons having ordinary skill in the art within the scope of claims and are included in the technical scope disclosed herein. The steps of the ECU 50 in the embodiment need not be executed in the order described above, and may be executed in different order without causing technical contradiction.

In the example of FIG. 6, the traveling direction of the vehicle 100 is the forward direction. In another example, the traveling direction of the vehicle 100 may be a backward direction. In this case, the backward movement is executed instead of the forward movement in Steps S100 to S106, and the forward movement is executed instead of the backward movement in Steps S108 to 114.

When the vehicle 100 does not move though the forward movement and the backward movement are switched a predetermined number of times in FIGS. 7 and 8, the processor 51 may terminate the operation.

The ECU 50 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the ECU 50 including the first executor 54 and the second executor 55. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vehicle comprising:
driving wheels comprising right and left front driving wheels and right and left rear driving wheels;
motors respectively and independently provided to the driving wheels; and
a controller configured to control the motors,
wherein the controller comprises one or more processors and one or more storage media configured to store a command to be executed by the one or more processors, and
wherein the one or more processors are configured to, based on the command when a predetermined operation is received from a driver who drives the vehicle,
detect, among the driving wheels, at least one driving wheel having a higher load and at least one driving wheel having a lower load, in forward movement,
detect, among the driving wheels, at least one driving wheel having a higher load and at least one driving wheel having a lower load, in backward movement, and
alternately switch the forward movement and the backward movement,
the forward movement comprising applying, to the at least one driving wheel having the lower load in the forward movement, a torque at which a slip ratio of 0% is obtained, and applying, to the at least one driving wheel having the higher load in the forward movement, a torque that causes a slip,
the backward movement comprising applying, to the at least one driving wheel having the lower load in the backward movement, a torque at which the slip ratio of 0% is obtained, and applying, to the at least one driving wheel having the higher load in the backward movement, a torque that causes a slip.

2. The vehicle according to claim 1, wherein the forward movement is switched to the backward movement when the forward movement is stopped, and the backward movement is switched to the forward movement when the backward movement is stopped.
